(19) United States
(12) Patent Application Publication
(10) Pub. No.: US 2024/0267357 A1
(43) Pub. Date: Aug. 8, 2024

(54) IEEE 802.1CQ MAC ADDRESS ALLOCATION VIA IEEE 1722 MAAP AND BARC

(71) Applicant: InterDigital Patent Holdings, Inc., Wilmington, DE (US)

(72) Inventors: Antonio de la Oliva, Madrid (ES); Robert Gazda, Spring City, PA (US)

(73) Assignee: InterDigital Patent Holdings, Inc., Wilmington, DE (US)

(21) Appl. No.: 18/030,890

(22) PCT Filed: Oct. 8, 2021
(86) PCT No.: PCT/US2021/054201

§ 371 Date: Apr. 7, 2023

Related U.S. Application Data
(60) Provisional application No. 63/210,779, filed on Jun. 15, 2021.
(60) Provisional application No. 63/089,284, filed on Oct. 8, 2020.

(51) Int. Cl. H04L 61/5038; H04L 61/5046; H04L 69/00; H04L 101/622; H04L 101/695

(52) U.S. Cl. CPC H04L 61/5038; H04L 61/5046; H04L 69/03; H04L 2101/622; H04L 2101/695

(57) ABSTRACT

A wireless transmit/receive unit (WTRU) comprising a receiver, a transmitter, and a processor, wherein the processor is configured to generate a Block Address Registration and Claiming (BARC) protocol data unit (PDU) including a BARC identifier, and an associated 4-bit state field, and further wherein the transmitter is configured to transmit the BARCPDU. The BARC identifier may include at least one of a claimable address block address (CABA), registerable address block identifier (RABI), or a proposed RABI (PRABI). The BARCPDU may be encoded as a IEEE 1722 message.

### CROSS-REFERENCE TO RELATED APPLICATIONS

This application claims the benefit of U.S. Provisional Application No. 63/089,284, filed Oct. 8, 2020 and U.S. Provisional Application No. 63/210,779, filed Jun. 15, 2021, the contents of which are incorporated herein by reference.

### SUMMARY

A method and apparatus for supporting backward compatibility of a message protocol are provided. A wireless transmit/receive unit (WTRU) may receive a message and determine: whether the message is of a legacy Media Access Control (MAC) Address Acquisition Protocol (MAAP) compatible version format; whether the message is of a legacy MAAP compatible version format having request_start_address, request_count, conflict_start_address and conflict_count fields set to 0; whether the message is not a message type of legacy MAAP; and whether the message is of a new IEEE 1722 AVB format version.

A wireless transmit/receive unit (WTRU) comprising a receiver, a transmitter, and a processor, wherein the processor is configured to generate a Block Address Registration and Claiming (BARC) protocol data unit (PDU) including a BARC identifier, and an associated 4-bit state field, and further wherein the transmitter is configured to transmit the BARCPDU. Furthermore, the BARC identifier may include at least one of a claimable address block address (CABA), registerable address block identifier (RABI), or a proposed RABI (PRABI). Furthermore, the BARC identifier may by 48-bits or 64-bits. Furthermore, the 4-bit field may be encoded as a bitmap, wherein the bitmap indicates states selected from a group comprising of: D (Discovery), C (Claimed), V (Vacant), R (Registered), I (Inquiry), P (Proposal), O (Offered), A (Address), N (Null), T (Token) and the corresponding states for the Register, RD, RC, RV and RX. Furthermore, the BARCPDU may be encoded as a IEEE 1722 message. Furthermore, the BARCPDU may be an IEEE 1722 alternate header.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an Institute of Electrical and Electronics Engineers (IEEE) 1722-2016 Media Access Control (MAC) Address Acquisition Protocol (MAAP) frame format;

FIG. 3 is a diagram illustrating an IEEE 802.1CQ/D0.5 message format;

FIG. 4 is a diagram illustrating an IEEE 1722 Alternate header;

FIG. 5 is a diagram illustrating an example format for a common IEEE 802.1CQ MAAP frame header;

FIG. 6 is a diagram illustrating an example IEEE 802.1CQ MAAP header considering a receiver/sender ID;

FIG. 7 is a diagram illustrating an example IEEE 802.1CQ MAAP header with a valid stream_id;

FIG. 8 is a diagram illustrating a first frame format, FORMAT 1;

FIG. 9 is a diagram illustrating a second frame format, FORMAT 2;

FIG. 10 is a diagram illustrating a third frame format, FORMAT 3;

FIG. 11 is a diagram illustrating a fourth frame format, FORMAT 4;

FIG. 12 is an diagram illustrating a Block Address Registration and Claiming (BARC) ID/State tuple (ID before state); and

FIG. 13 is a diagram illustrating an example of a BARC ID/State tuple (state before ID).

### DETAILED DESCRIPTION

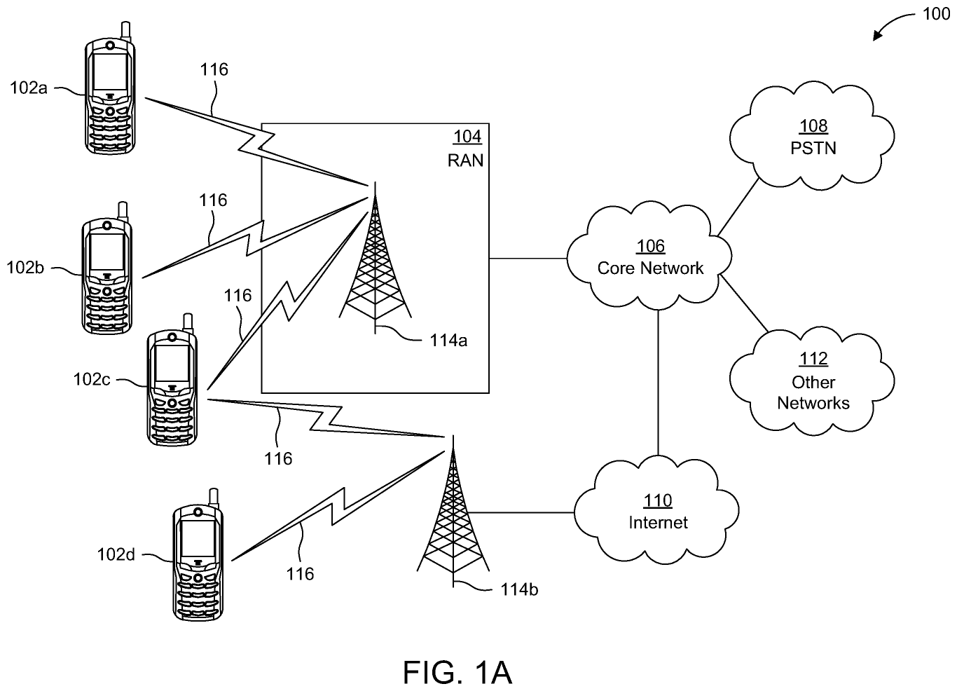

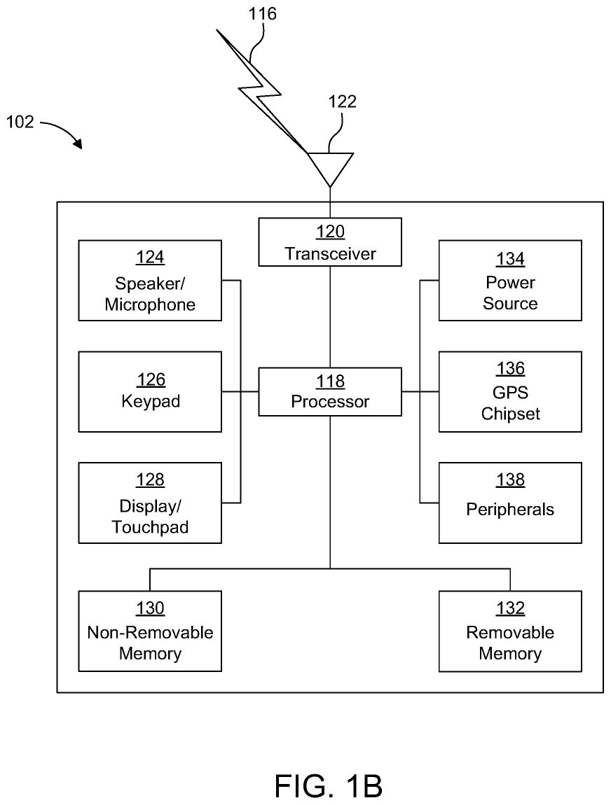

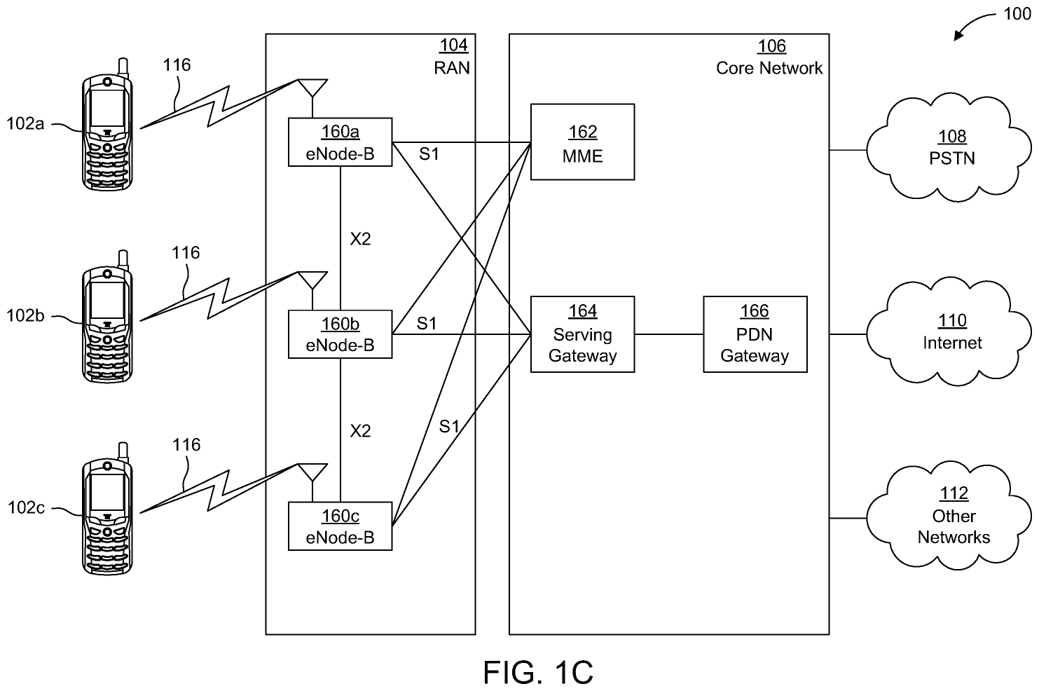

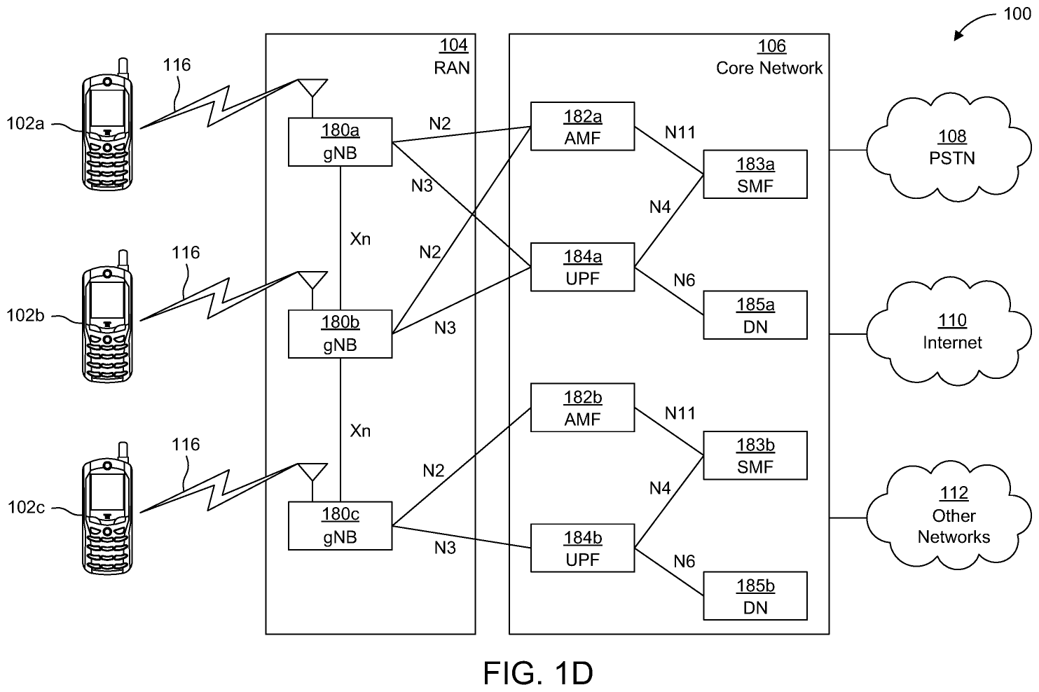

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as Institute of Electrical and Electronics Engineers (IEEE) 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

IEEE 802.1CQ has entered into a first task group ballot. The ballot results show that a critical majority of participants are pushing for a compatible message format between IEEE 802.1CQ and IEEE 1722-2016 MAC Address Acquisition Protocol. A format for IEEE 802.1CQ defined messages, which is compatible with the flexible header format of IEEE 1722-2016 AVB, is disclosed. In an embodiment, a new frame format for the Block Address Registration and Claiming (BARC) proposal for IEEE 802.1CQ is disclosed.

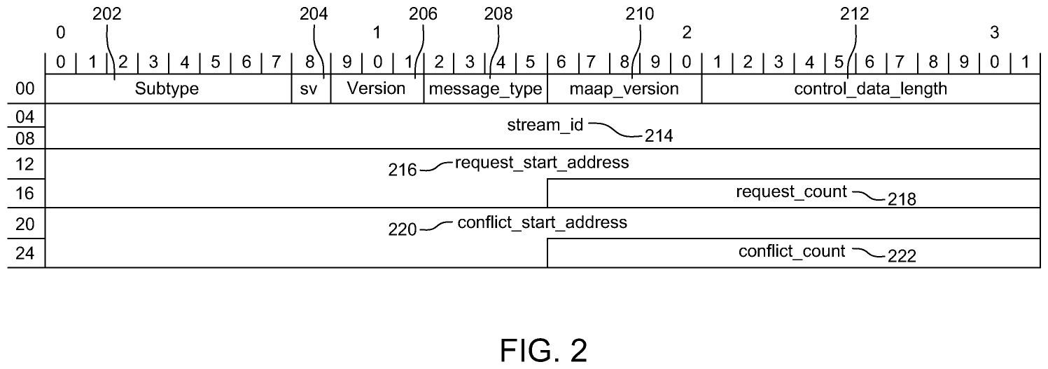

FIG. 2 illustrates an IEEE 1722-2016 Media Access Control (MAC) Address Acquisition Protocol (MAAP) MAAP message format. Herein, the MAAP protocol version as defined by IEEE 1722-2016 may be referred to as legacy MAAP. IEEE 1722-2016 defines the format illustrated by FIG. 2 for legacy MAAP messages.

Each of the fields in the header portion of FIG. 2 may be defined as follows. The subtype field 202 may indicate legacy MAAP as defined in 4.4.3.2 of IEEE 1722-2016. The sv bit field 204 may indicate if the stream_id field 214 carries a valid stream id, which as defined in section 4.4.4.2 of IEEE 1722-2016. The stream id bit always has a value of 1. The version field 206 may specify the version of the format. Unless explicitly defined by a format definition, the version field 206 is set to zero (0) on transmit and verified on receive. The message type field 208 is indicated in Table B.1 of IEEE 1722-2016 and includes the MAAP_PROBE, MAAP_DEFEND and MAAP_ANNOUNCE message types. The maap_version field 210 may identify the version of MAAP being used. The current version for legacy MAAP is one(1). The control_data_length field 212 may be set to 1610 in all legacy MAAP frames. The stream_id field 214 is not used in legacy MAAP and may always be set to zero (0).

The requested_start_address field 216 in a MAAP_PROBE or MAAP_ANNOUNCE message may be the first address of a consecutive range of addresses being requested. In a MAAP_DEFEND message, requested_start_address field 216 may be set to the requested_start_address value received in the MAAP_PROBE or MAAP_ANNOUNCE PDU that initiated the transaction.

The requested_count field 218 in a MAAP_PROBE or MAAP_ANNOUNCE message is the number of addresses being requested. If only a single address is being requested, requested_count field 218 is set to one (1). In a MAAP_DEFEND message, requested_count field 218 may be set to the requested_count value received in the MAAP_PROBE or MAAP_ANNOUNCE PDU that initiated the transaction.

The conflict_start_address field 220 in a MAAP_DEFEND message may be set to the first address that conflicts with a requested address range from a MAAP_PROBE PDU. In all other legacy MAAP messages, conflict_start_address field 220 field is set to zero (0).

The conflict_count field 222 in a MAAP_DEFEND message is set to the number of addresses in the allocated address range, beginning with conflict_start_address, that conflicts with a requested address range from a MAAP PROBE PDU. In all other legacy MAAP messages, this field is set to zero (0).

IEEE 1722-2016 indicates the following behavior for backwards compatibility of new versions of the protocol: MAAP Audio Video Transport Protocol (AVTP) Protocol Data Units (PDUs) (AVTPDUs) that carry a maap_version higher than the protocol version implemented by the receiver may be interpreted according to the protocol definition of the receiver's implemented version.

All MAAP AVTPDUs received that contain a higher maap_version number and a message type that is defined in the implemented version of MAAP may be interpreted using the implemented version of MAAP, ignoring all unknown fields. This requires that future versions of MAAP maintain compatibility with the message types and formats implemented in all previous versions of MAAP.

All MAAP AVTPDUs received that contain a higher version number and a message type that is not defined in the implemented version of MAAP may be ignored.

MAAP AVTPDUs that carry a maap_version lower than the protocol version implemented by the receiver may be interpreted according to the protocol definition corresponding to the protocol version received in the MAAP AVTPDU. This requires that future versions of MAAP maintain the ability to interpret MAAP AVTPDUs from all previous versions of MAAP.

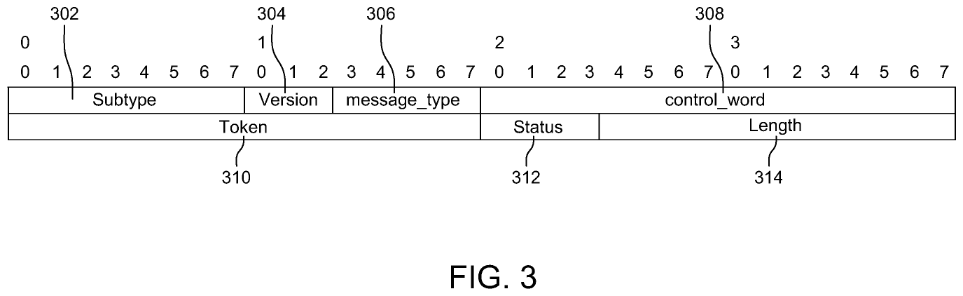

FIG. 3 is a diagram illustrating an IEEE 802.1CQ/D0.5 message format. The Protocol for Assignment of Local and Multicast Addresses (PALMA) as defined in IEEE 802.1CQ/D0.5 specifies 7 different messages: DISCOVER, OFFER, REQUEST, ACK, RELEASE, DEFEND and ANNOUNCE. All messages share a common header which is illustrated by FIG. 3.

The subtype field 302 may identify the protocol as PALMA, it should be made compatible with Table 6 of IEEE 1722-2016. The version field 304 may indicate the version of the PALMA protocol, defined as 0 for the initial version of this protocol. The message_type field 306 may indicate the type of message transported. message_type field 306 may take the values DISCOVER, OFFER, REQUEST, ACK, RELEASE, DEFEND and ANNOUNCE, as defined in Table 7 of IEEE 802.1CQ/D0.5. The control_word field 308 is defined in Table 8 of IEEE 802.1CQ/D0.5, and includes a bitmap of indicators for the operation of the protocol. The token field 310 may identify the series of messages in a message exchange between a PALMA client and server. The status field 312 may indicate the result of the operation, as defined in Table 9 of IEEE 802.1CQ/D0.5. The length field 314 may indicate the length in octets of the complete message.

For each message, IEEE 802.1CQ defines a set of parameters that may be included in the message. The different parameters are as follows: Station ID; MAC Address Set; Network ID; Lifetime; Client Address Parameter and Vendor Specific. IEEE 802.1CQ defines for each message type the different optional and mandatory parameters that should be included in the message.

IEEE 1722 defines three different headers including: (1) Control, (2) Stream, and (3) Alternate. The Stream header may be used to encapsulate data belonging to a certain multimedia flow or stream. The Control header may be used by different parts of the IEEE 1722 standard, for control or management purposes, for example, MAAP uses the Control header. The Alternate header may allow the definition of application specific headers, just including a minimum set of common information with the rest of IEEE 1722 encodings.

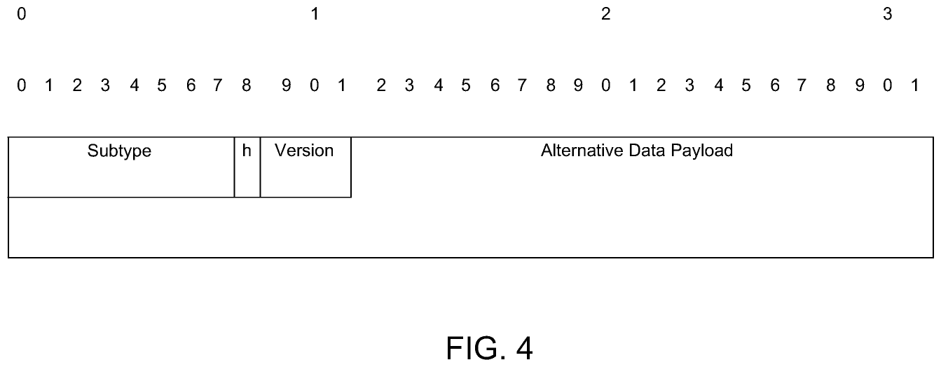

FIG. 4 illustrates an Alternate header. Encapsulation of IEEE 802.1CQ/D0.5 may be compatible with IEEE 1722. Embodiments disclosed herein modify the header of the messages defined in IEEE 802.1CQ/D0.5 to be backwards compatible with IEEE 1722-2016. One approach makes use of the IEEE 1722-2016 AVTPDU common control header and re-defines the MAAP stream_id field, so that the 64 bits of the stream_id are used to accommodate the information carried in the IEEE 802.1CQ/D0.5 header. This may be complemented with the use of the SV bit of the common header, indicating there may be no valid stream_id.

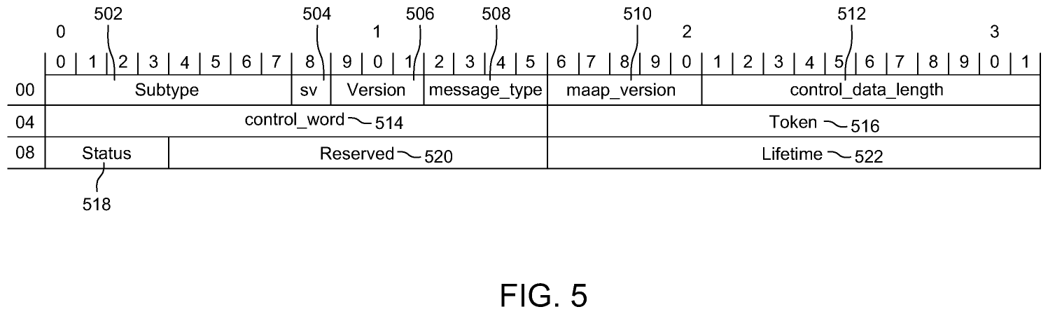

FIG. 5 is a diagram illustrating a proposed format for common IEEE 802.1CQ MAAP frame header. Considering the new definition of the MAAP stream_id field, the header for IEEE 802.1CQ protocol that is compatible with MAAP, common to all CQ messages may be shown according to FIG. 5. Fields may be reordered in examples.

The subtype field 502 may indicate MAAP as defined in 4.4.3.2 of IEEE 1722-2016. The sv bit field 504 may indicate if the stream_id carries a valid stream id. As a difference with legacy MAAP, in the IEEE 802.1CQ new MAAP format, it may be set to 0, indicating that the stream_id field does not carry a valid stream ID. The version field 506 specifies the version of the format. Unless explicitly defined by a format definition, this field may be set to zero (0) on transmit and verified on receive. Some messages of IEEE 802.1CQ, following the new format such as MAAP_DEFEND or DISCOVER may use two different formats depending on its use, this may be indicated with a version of 0 or 1 on this field.

The message type field 508 may be compatible with IEEE 802.1CQ/D0.5 which defines the following messages: DISCOVER, PROBE, DEFEND, ANNOUNCE, OFFER, REQUEST, RELEASE and ACK. New messages may be defined, such as the definition of a new PROBE message is compatible with MAAP. The maap_version field 510 may identify the version of MAAP being used. The current version of legacy MAAP is one (1), IEEE 802.1CQ MAAP version may be defined as version two (2). The control_data_length field 512 may contain the total length of the message in octets.

A control_word field 514 may be defined as per Table 8 of IEEE 802.1CQ/D0.5, it may include a bitmap of indicators for the operation of the protocol. The token field 516 may identify the series of messages in a message exchange between an IEEE 802.1CQ client and server. The status field 518 may indicate the result of the operation, as may be defined in Table 9 of IEEE 802.1CQ/D0.5. The reserved field 520 in the header may include, among others, an indication of the sender ID of the message. It may encode in 12 bits a client or server identifier. The lifetime field 522 may indicate the lifetime requested for the lease, the lifetime of the lease or may be 0 if no lifetime is indicated. The lifetime may be defined in seconds.

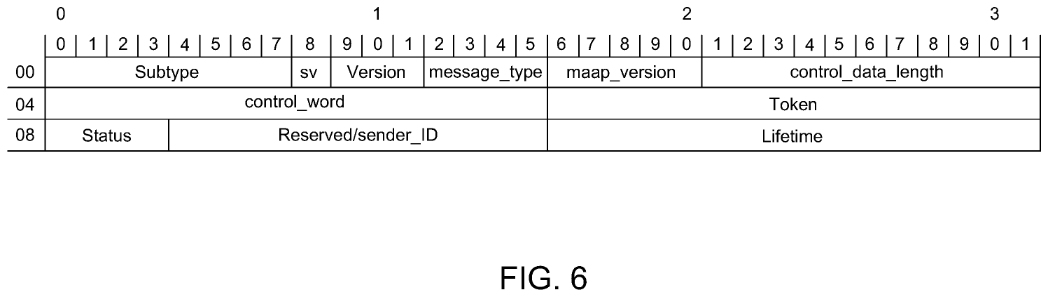

FIG. 6 is an illustration of a complete format of the common header considering also the use of the reserved field for carrying the sender ID. In case the MAAP stream_id may be set to 0, for example, the CQ parameters may not be carried in the stream_id, the CQ fields may be transported as an independent 64 field, either after the stream_id or after the 128 bits considering the addresses (request_start_address and conflict_start_address) in the legacy MAAP frame format.

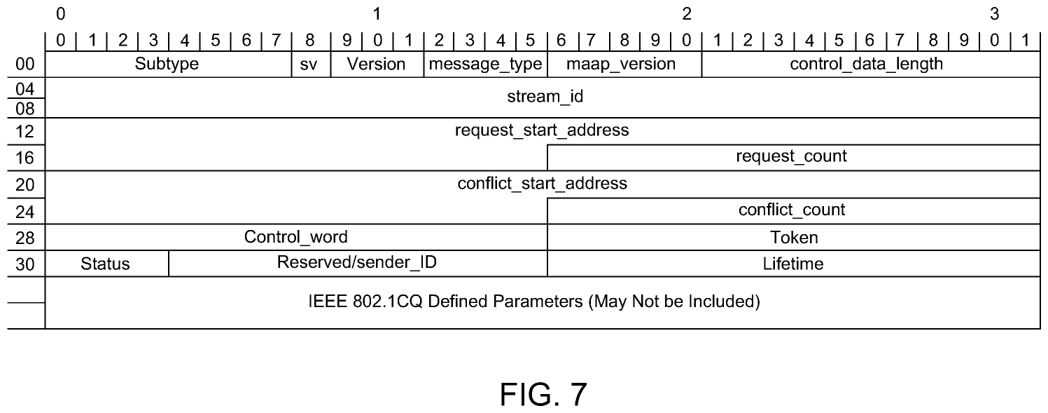

FIG. 7 is a diagram illustrating a proposed IEEE 802.1CQ MAAP header with a valid stream_id. Mechanisms may be applied to make IEEE 802.1CQ messages backward compatible with IEEE 1722-2016. In an embodiment, a new value for the format version is used. In this way, two different formats for messages that may be compatible with legacy MAAP and messages which may not, even for the same message type, may be defined. For example, MAAP_DEFEND may use two versions of the format, one compatible with legacy MAAP in case it is triggered by a MAAP_PROBE and a different one if the MAAP_DEFEND is triggered by a DISCOVER message.

In an embodiment, the same message format as in legacy MAAP, but including the new fields in the stream_id field while setting to 0 the fields request_start_address, request_count, conflict_start_address and conflict_count, may be used.

Applying the above mechanisms, the IEEE 802.1CQ messages may fall into the following four categories denoted at FORMAT 1 to FORMAT 4. FORMAT 1 and FORMAT 2 may be fully compatible with legacy MAAP formats. FORMAT 3 and FORMAT 4 are formats that may be used as IEEE 802.1CQ versions of legacy MAAP messages, for example, by modifying the version field. These formats may be used for new messages.

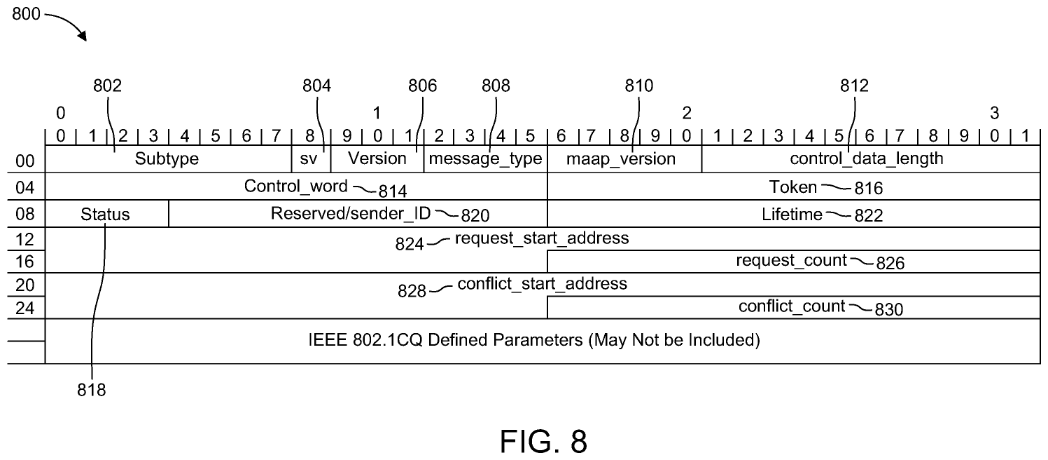

FIG. 8 is a diagram illustrating a first frame format 800, FORMAT 1. FORMAT 1 may use a legacy MAAP compatible version format with subtype field 802, sv bit field 804, vesion field 806, message_type field 808, maap_version field 810, control_data_length field 812, control_word field 814, token field 816, status field 818, reserved/sender field 820, lifetime field 822, and valid request_start_address field 824, request_count field 826, conflict_start_address field 828 and conflict_count field 830. FORMAT 1 may include an sv bit set to an invalid stream_id and a flag in a control_word field 814 that may indicate the validity of request_start_address field 824, request_count field 826, conflict_start_address field 828 and conflict_count field 830. The version field 806 may be set to 0 (indicating the version as defined in IEEE 1722-2016) in this case.

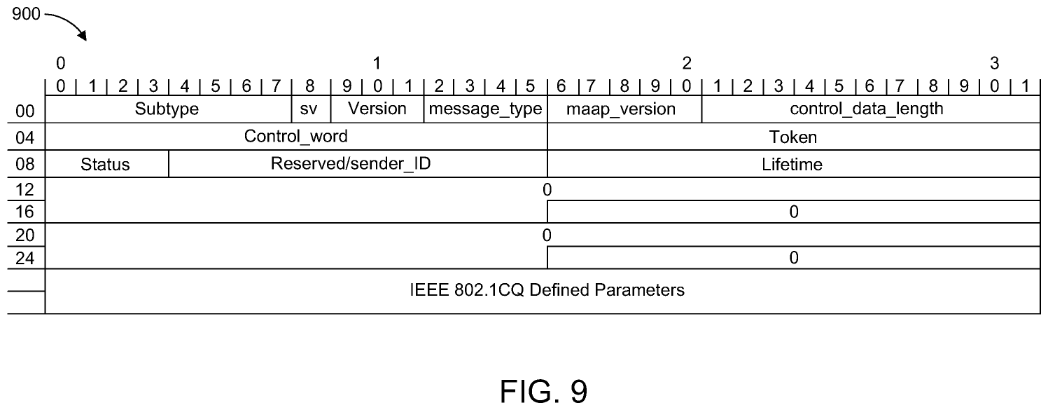

FIG. 9 is a diagram illustrating a second frame format 900, FORMAT 2. FORMAT 2 may use a legacy MAAP compatible version format with request_start_address, request_count, conflict_start_address and conflict_count set to 0. This format may be similar to FORMAT 1 but the flag in the control_word may indicate invalidity of the request_start_address, request_count, conflict_start_address and conflict_count fields, which may be set to 0. FORMAT 2 may include an sv bit set to an invalid stream_id and a flag set in the control_word field that may indicate the invalid use of request_start_address, request_count, conflict_start_address and conflict_count fields. The version field may be set to 0 (indicating the version as defined in IEEE 1722-2016) in this case.

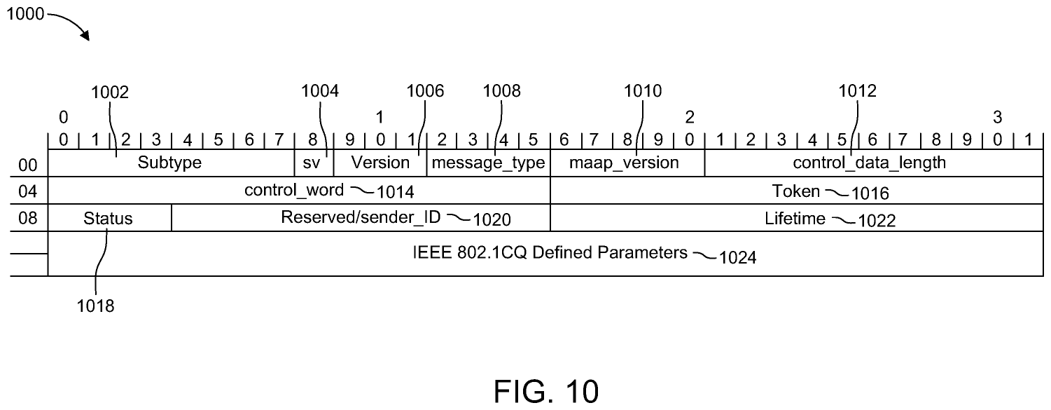

FIG. 10 is a diagram illustrating a third frame format 1000, FORMAT 3. FORMAT 3 may be used for new messages. The third frame format 1000 may have the following fields: subtype field 1002, sv bit field 1004, version field 1008, mapp_version filed 1010, control_data_lenght field 1012, control_word field 1014, token field 1016, status field 1018, reserved/sender_ID field 1020, and lifetime field 1022. FORMAT 3 1000 may also include a IEEE 802.1CQ defined parameters field 1024.

This message may be processed by legacy MAAP up to the message_type field 1008 where it may indicate a new message type (compared with message types of legacy MAAP), so legacy MAAP clients may not process it. FORMAT 3 may include an sv bit field 1004 set to an invalid stream_id and a flag in the control_word field 1014 that may indicate the invalid use of request_start_address field, request_count field, conflict_start_address field and conflict_count field. This message may be used for new messages, not included in message_type for the legacy version of MAAP.

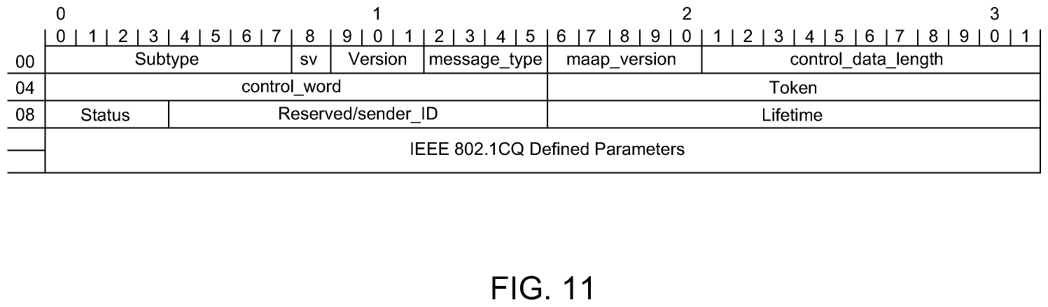

FIG. 11 is a diagram illustrating a fourth frame format, 1100 FORMAT 4. FORMAT 4 may use a new MAAP version format as indicated in the version field of the header. This may be used to have one single message type (message_type) but with two differentiated formats. It should be noted that this message may require the transmission of different formats depending on the trigger of the sending of the message. Messages implementing FORMAT 4 may also have another format (with version 0) which may be FORMAT 1 or FORMAT 2. FORMAT 4 may include an sv bit set to an invalid stream_id and a flag set in the control_word field that may indicate no use of request_start_address, request_count, conflict_start_address and conflict_count fields. The version field may be set to 1 (indicating a new version different from the one defined in IEEE 1722-2016) in this case.

The messages as defined in these new formats may be in accordance with the descriptions in Table 1 below.

TABLE 1
Example List of IEEE 802.1CQ Messages

| Value | | |
|---|---|---|
| (Example) | Function | Description |
| 0₁₆ | — | Reserved |
| 1₁₆ | MAAP_PROBE | Probe MAC address(es) PDU |
| 2₁₆ | MAAP_DEFEND | Defend address(es) response PDU |
| 3₁₆ | MAAP_ANNOUNCE | Announce MAC address(es) acquired |
| | | PDU |
| 4₁₆ | DISCOVER | Discover MAC address(es) PDU |
| 5₁₆ | OFFER | Offer MAC address(es) PDU |
| 6₁₆ | REQUEST | Request MAC address(es) PDU |
| 7₁₆ | ACK | Acknowledge MAC address(es) PDU |
| 8₁₆ | RELEASE | Release MAC address(es) PDU |
| 9₁₆-F₁₆ | — | Reserved |

Some of the messages in the above table may be collapsed or duplicated depending on the format choice. For example, MAAP_PROBE and DISCOVER may be collapsed in a single message while MAAP_DEFEND may be split in two different messages, one for IEEE 802.1CQ protocol and another compatible with MAAP.

If a full split of messages in IEEE 802.1CQ and compatible with MAAP messages is considered, Table 1 may be modified as is shown in Table 2 below.

TABLE 2
Example List of IEEE 802.1CQ Messages (Full Split of Messages)

| Value | | |
|---|---|---|
| (Example) | Function | Description |
| 0₁₆ | — | Reserved |
| 1₁₆ | MAAP_PROBE | Probe MAC address(es) PDU |
| 2₁₆ | MAAP_DEFEND | Defend address(es) response PDU |
| 3₁₆ | MAAP_ANNOUNCE | Announce MAC address(es) acquired |
| | | PDU |
| 4₁₆ | DISCOVER | Discover MAC address(es) PDU |
| 5₁₆ | OFFER | Offer MAC address(es) PDU |
| 6₁₆ | REQUEST | Request MAC address(es) PDU |
| 7₁₆ | ACK | Acknowledge MAC address(es) PDU |
| 8₁₆ | RELEASE | Release MAC address(es) PDU |
| 9₁₆ | IEEE8021CQ_{—} | Defend addresses in the 802.1CQ |
| | DEFEND | ranges |
| A₁₆ | IEEE8021CQ_{—} | Announce addresses in the 802.1CQ |
| | ANNOUNCE | ranges |
| B₁₆-F₁₆ | — | Reserved |

If messages are joined and differentiated by a format of the messages, the message_type field may include values from the next table as is shown by Table 3.

TABLE 3
Example List of IEEE 802.1CQ Messages
(With Some Joined Messages)

| Value | | |
|---|---|---|
| (Example) | Function | Description |
| 0₁₆ | — | Reserved |
| 1₁₆ | MAAP_PROBE/ | Probe/Discover MAC |
| | DISCOVER | address(es) PDU |
| 2₁₆ | MAAP_DEFEND | Defend address(es) response |
| | | PDU |
| 3₁₆ | MAAP_ANNOUNCE | Announce MAC address(es) |
| | | acquired PDU |
| 4₁₆ | OFFER | Offer MAC address(es) PDU |
| 5₁₆ | REQUEST | Request MAC address(es) PDU |
| 6₁₆ | ACK | Acknowledge MAC address(es) |
| | | PDU |
| 7₁₆ | RELEASE | Release MAC address(es) PDU |
| 8₁₆-F₁₆ | — | Reserved |

A new parameter, Receiver ID, may be defined in IEEE 802.1CQ. Table 4 below modifies Table 10 of IEEE 802.1CQ/D0.5.

TABLE 4
Modification to Table 10 of IEEE 802.1CQ/D0.5

| Parameter ID | Parameter subfield type |
|---|---|
| 7 | Receiver ID |

The Receiver ID may include information on the ID of the expected receiver of the message. It may replace the Network ID or Station ID in current IEEE 802.1CQ/D0.5. Table 5 illustrates an exemplary format of this parameter.

TABLE 5
Receiver ID Format

| Parameter ID | Received Identifier |
|---|---|
| 1 octet | 12 bits |

The control_word field as defined in Table 8 of IEEE 802.1CQ/D0.5 may be modified to incorporate new control fields as shown in Table 6 below.

TABLE 6
Modifications to Table 8 of IEEE 802.1CQ/D0.5

| Bit | Name | Description |
|---|---|---|
| 0-5 | As per Table 8 IEEE 802.1CQ/D0.5 | As per Table 8 IEEE 802.1CQ/D0.5 |
| 6 | request and conflict addresses in use | Bit set to 1: The fields request_start_address, |
| | (writing may change) | request_count, conflict_start_address, conflict_count are |
| | | valid |
| | | Bit set to 0: The fields request_start_address, |
| | | request_count, conflict_start_address, conflict_count are |
| | | not valid or not present |
| 7-9 | As per Table 8 IEEE 802.1CQ/D0.5 | As per Table 8 IEEE 802.1CQ/D0.5 |
| 10 | Status field provided | Bit set to 1: The message contains a status field. |
| | | Bit set to 0: The message does not contain a status field. |

A message format definition may be employed, per an implementation of this new format, for each of the messages defined above.

A MAAP_PROBE message may be used to probe multicast addresses in the range allocated to IEEE 1722-2016, therefore it may comply with the backwards compatibility rules as defined in IEEE 1722-2016, since it may be potentially received by MAAP clients:

All MAAP AVTPDUs received that contain a higher version number and a message type that is defined in the implemented version of MAAP may be interpreted using the implemented version of MAAP, ignoring all unknown fields.

A MAAP_PROBE may use FORMAT 1 in order to be compatible with legacy MAAP. In addition, this message may carry a Vendor specific field, Client Address Parameter or Station ID field as defined in IEEE 802.1CQ/D0.5 in the IEEE 802.1CQ defined Parameters field.

A DISCOVER message may be defined as an independent message or as a new format version for the MAAP_PROBE message. DISCOVER messages may include information of addresses which are not allocated to IEEE 1722-2016, and may or may not be received by legacy MAAP devices. In case a fully compatible message with legacy MAAP is desired, FORMAT 1 or FORMAT 2 (as defined above) may be used. In case DISCOVER is defined as a new format for the MAAP_PROBE (or vice versa) it may use FORMAT 4, finally if a new message is defined, FORMAT 3 may be used. In addition, DISCOVER messages may carry the parameters as defined in IEEE 802.1CQ/D0.5. MAC Address Set Parameter, Client Address Parameter, Station ID, and Vendor Specific Parameters along with the newly defined Receiver_ID Parameter may be transported in the IEEE 802.1CQ defined Parameters field.

A MAAP_DEFEND message may be used to defend already allocated addresses in the range used by IEEE 1722-2016, or in the ranges defined in IEEE 802.1CQ. This message may be unicasted to the source address of the MAAP_PROBE or DISCOVERY message triggering the MAAP_DEFEND message. Therefore, its format may include two variants depending on the version of the PROBE or DISCOVER message triggering the DEFEND. In case the MAAP_DEFEND message may be triggered by MAAP_PROBE as defined in this document, FORMAT 1 may be used. In case the MAAP_DEFEND message may be triggered by a DISCOVER message (or a MAAP_PROBE message with version different from 0), then the message may use FORMAT 3 or 4. In addition, this message may carry a Vendor specific, Client Address Parameter or Station ID as defined in IEEE 802.1CQ/D0.5. It may also carry the newly defined (in this document) Receiver ID Parameter or different instances of MAC Address Set parameters.

A MAAP_ANNOUNCE message may be used to periodically announce allocated multicast addresses in the range used by IEEE 1722-2016, or in the ranges used by IEEE 802.1CQ. Therefore, it may comply with the backwards compatibility rules as defined in IEEE 1722-2016, since it may be received by MAAP clients. In an embodiment, the destination address may be the multicast address assigned to MAAP. This message may use FORMAT 1 when announcing addresses in the IEEE 1722-2016 address range. It may use FORMAT 2 for announcing addresses in other range from IEEE 1722-2016. It may also use FORMAT 4 in case two separated formats are used depending on the address range defended, or finally it may be split in two messages, one for legacy MAAP and another for IEEE 802.1CQ using FORMAT 3.

In all cases, the header may be followed by one or more of: MAC Address Set Parameters, Lifetime Parameter, Station ID Parameter or the newly defined (in this document) Receiver ID Parameter.

OFFER, REQUEST, ACK and RELEASE messages are specific to the server-based allocation in IEEE 802.1CQ and may not be received by legacy MAAP clients. Therefore, all of them may use FORMAT 3.

BARC messages are simpler than PALMA ones, since the state is communicated in every transaction. BARC communication is based on exchanging MAC addresses or identifiers of the same length as the MAC address being used and an accompanying state. This state is one of 14 different states defined in BARC.

The states defined in BARC are D (Discovery), C (Claimed), V (Vacant), R (Registered), I (Inquiry), P (Proposal), O (Offered), A (Address), N (Null), T (Token) and the corresponding states for the Register, RD, RC, RV and RX.

The main element being exchanged in a BARC communication is a group of a 48-bits or a 64-bits identifier (e.g., a MAC Address or Token) and a variable to record the state, which is referred to as a BARC ID/State tuple.

In embodiments, there are different ways with which state information may be encoded, for example: as a 16-bit bitmap, where each bit may indicate the state. For example, Table 7 below illustrates an exemplary 16-bit bitmap.

TABLE 7
Example of the BARC State Encoding (16-bit bitmap)

| | Rsvd | Rsvd | D | C | V | R | I | P | O | A | N | T | RD | RC | RV | RX |
|---|---|---|---|---|---|---|---|---|---|---|---|---|---|---|---|---|
| Bit | 0 | 1 | 2 | 3 | 4 | 5 | 6 | 7 | 8 | 9 | 10 | 11 | 12 | 13 | 14 | 15 |

The two bits not used to encode state (in this example Bit 0 and 1, but may be any other), may be reserved, or may be used in the future to extend the possible states. In an embodiment, two extra states may be added for each bit, or the bits may be used as masks to encode another 3 sets of 14 bits. A first set will have bit 0 and 1 as 00, the second set would be 01, the third 10 and the fourth possible set would be 11. In this example, 00 may be reserved for this specific set of state configurations.

Another way in which state information may be encoded is as an octet, where values from 0 to 255 may indicate the value of the state. In this case, an example of the encoding may be given by Table 8 below.

TABLE 8
Example of BARC State Encoding (Octet)

| Value | State |
|---|---|
| 0 | D |
| 1 | C |
| 2 | V |
| 3 | R |
| 4 | I |
| 5 | P |
| 6 | O |
| 7 | A |
| 8 | N |
| 9 | T |
| 10 | RD |
| 11 | RC |
| 12 | RV |
| 13 | RX |
| 14-255 | Reserved |

It should be noted that the assignment of values to states gathered in this table is just one example and alternative assignments may be used.

Another way in which state information may be encoded is as a 4-bit nibble, where values from 0 to 16 may indicate the value of the state. In this case, an example of the encoding may be given by Table 9 below.

TABLE 9
Example of BARC State Encoding (4-bit nibble)

| Value | State |
|---|---|
| 0 | D |
| 1 | C |
| 2 | V |
| 3 | R |
| 4 | I |
| 5 | P |
| 6 | O |
| 7 | A |
| 8 | N |
| 9 | T |
| 10 | RD |
| 11 | RC |
| 12 | RV |
| 13 | RX |
| 14-15 | Reserved |

It should be noted that the assignment of values to states gathered in this table is just one example and alternative assignments may be used.

Another way in which state information may be encoded is as a 14-bit bitmap, where each bit may indicate the state. For example, the 14-bit bitmap may be encoded as is shown in Table 10 below.

TABLE 10
Example of BARC State Encoding (14-bit Bitmap)

| | D | C | V | R | I | P | O | A | N | T | RD | RC | RV | RX |
|---|---|---|---|---|---|---|---|---|---|---|---|---|---|---|
| Bit | 0 | 1 | 2 | 3 | 4 | 5 | 6 | 7 | 8 | 9 | 10 | 11 | 12 | 13 |

It should be noted that the assignment of bits to states is just one example and alternative assignments may be used.

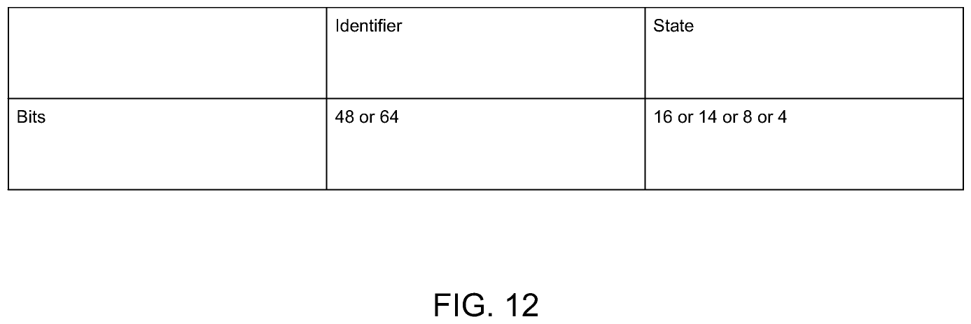

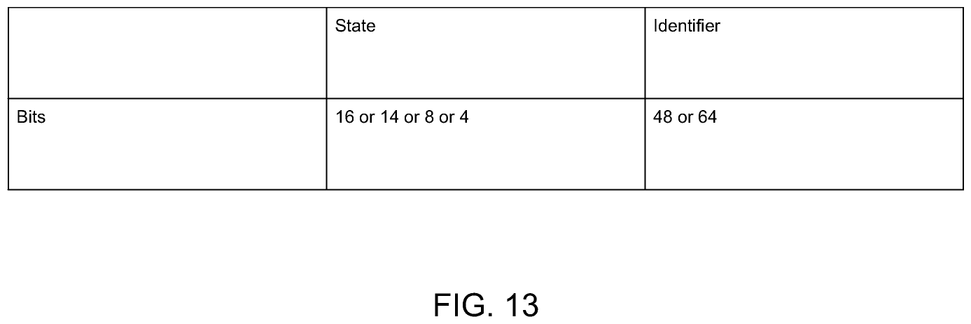

FIG. 12 is an diagram illustrating a BARC ID/State tuple (ID before state) and FIG. 13 is a diagram illustrating an example of a BARC ID/State tuple (state before ID). Once the state has been coded, the BARC ID/State tuple may take form as is shown in FIG. 12 or FIG. 13.

This may result in the following different encapsulations, denoted by BARC_sizeID_sizeState. Where sizeID represents the size of the identifier (e.g., 48-bit or 64-bit MAC address or token), and sizeState represents the encoding of the state as defined above: BARC_48_16 of 64 bits of length; BARC_48_14 of 62 bits of length; BARC_48_8 of 54 bits of length; BARC_48_4 of 52 bits of length; BARC_64_16 of 80 bits of length; BARC_64_14 of 78 bits of length; BARC_64_8 of 72 bits of length; BARC_64_4 of 68 bits of length. All of these encodings may encapsulate the state before the ID or the other way around, as shown in FIG. 12 and FIG. 13.

A BARC message may be composed of 2 or 3 BARC ID/State tuples. There may be different mechanisms to encapsulate this information; using IEEE 1722 headers (control or alternate) and using the ethertype defined for IEEE 1722 (using a new subtype), or using a new ethertype and define a new header from scratch.

For BARC messages, an encapsulation based on the IEEE 1722 Alternate header and a fixed or variable message size may be used.

Using a fixed size, it may be assumed that after the IEEE 1722 Alternate header, 3 BARC ID/State tuples are added always. In case a tuple is not needed, it may be indicated by the state None (N). In this case, depending on the encoding chosen (BARC_sizeID_sizeState), and assuming the IEEE 1722 alternate header, the message may have a fixed size of 12 bits (IEEE 1722 Alternate header)+3x length (BARC_sizeID_sizeState). It should be noted that some extra bits for padding may be needed to align the length of the message. This way of encapsulation may also be done using the IEEE 1722 defined control header, where one of the BARC ID/State tuples may be added in the stream ID field, as in previous examples above.

Using a variable size, instead of having a fixed length, BARC messages may be variable, with some cases exchanging 3 BARC ID/State tuples and other cases exchanging 2 BARC ID/State tuples. In this case, the number of BARC ID/State tuples contained in the message may be computed either from a new header field incorporated including the length or by inspection of the size of the packet.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-14. (canceled)

15. An apparatus comprising:
a transceiver; and
a processor configured to:
generate a Block Address Registration and Claiming (BARC) protocol data unit (PDU) configured to provide for an assignment of at least one of a unicast address or multicast address, wherein the BARC PDU comprises a fixed size and includes fields having a predefined size, wherein the BARC PDU includes a 48-bit BARC identifier or address for BARC communications, and an associated 4-bit state field including a value indicating at least one BARC state of a plurality of BARC states defined for the BARC communications; and
transmit, via the transceiver, the BARC PDU.

16. The apparatus of claim 15, wherein the processor is configured to encode the BARC PDU as an IEEE 1722 message.

17. The apparatus of claim 15, wherein the BARC PDU comprises an alternative Audio Video Transport Protocol (AVTP) Protocol Data Units (PDUs) header of IEEE 1722.

18. The apparatus of claim 15, wherein the BARC identifier includes at least one of a claimable address block address (CABA), a registerable address block identifier (RABI), or a proposed RABI (PRABI).

19. The apparatus of claim 15, wherein the 4-bit state field indicates at least one of the following states: D (Discovery), C (Claimed), V (Vacant), R (Registered), I (Inquiry), P (Proposal), O (Offered), A (Address), N (Null), T (Token), or corresponding states for the Register, RD, RC, RV and RX.

20. The apparatus of claim 15, wherein the BARC identifier or address is based on or comprises a medium access control (MAC) address for a device receiving the BARC communications.

21. A method comprising:
generating a Block Address Registration and Claiming (BARC) protocol data unit (PDU) configured to provide for an assignment of at least one of a unicast address or multicast address, wherein the BARC PDU comprises a fixed size and includes fields having a predefined size, wherein the BARC PDU includes a 48-bit BARC identifier or address for BARC communications, and an associated 4-bit state field including a value indicating at least one BARC state of a plurality of BARC states defined for the BARC communications; and
transmitting the BARC PDU.

22. The method of claim 21, further comprising encoding the BARC PDU as an IEEE 1722 message.

23. The method of claim 21, wherein the BARC PDU comprises an alternative Audio Video Transport Protocol (AVTP) Protocol Data Units (PDUs) header of IEEE 1722.

24. The method of claim 21, wherein the BARC identifier includes at least one of a claimable address block address (CABA), a registerable address block identifier (RABI), or a proposed RABI (PRABI).

25. The method of claim 21, wherein the 4-bit state field indicates at least one of the following states: D (Discovery), C (Claimed), V (Vacant), R (Registered), I (Inquiry), P (Proposal), O (Offered), A (Address), N (Null), T (Token), or corresponding states for the Register, RD, RC, RV and RX.

26. The method of claim 21, wherein the BARC identifier or address is based on or comprises a medium access control (MAC) address for a device receiving the BARC communications.

27. An apparatus comprising:
a transceiver; and
a processor configured to:
receive, via the transceiver, a Block Address Registration and Claiming (BARC) protocol data unit (PDU) configured to provide for an assignment of at least one of a unicast address or multicast address, wherein the BARC PDU comprises a fixed size and includes fields having a predefined size, wherein the BARC PDU includes a 48-bit BARC identifier or address for BARC communications, and an associated 4-bit state field including a value indicating at least one BARC state of a plurality of BARC states defined for the BARC communications; and
process, based on the BARC identifier or address, the BARC PDU as a BARC communication for the apparatus.

28. The apparatus of claim 27, wherein the BARC PDU comprises an alternative Audio Video Transport Protocol (AVTP) Protocol Data Units (PDUs) header of IEEE 1722.

29. The apparatus of claim 27, wherein the 4-bit state field indicates at least one of the following states: D (Discovery), C (Claimed), V (Vacant), R (Registered), I (Inquiry), P (Proposal), O (Offered), A (Address), N (Null), T (Token), or corresponding states for the Register, RD, RC, RV and RX.

30. The apparatus of claim 27, wherein the BARC identifier or address is based on or comprises a medium access control (MAC) address for a device receiving the BARC communications.

31. A method comprising:
Receiving a Block Address Registration and Claiming (BARC) protocol data unit (PDU) configured to provide for an assignment of at least one of a unicast address or multicast address, wherein the BARC PDU comprises a fixed size and includes fields having a predefined size, wherein the BARC PDU includes a 48-bit BARC identifier or address for BARC communications, and an associated 4-bit state field including a value indicating at least one BARC state of a plurality of BARC states defined for the BARC communications; and
processing, based on the BARC identifier or address, the BARC PDU as a BARC communication for the apparatus.

32. The method of claim 31, wherein the BARC PDU comprises an alternative Audio Video Transport Protocol (AVTP) Protocol Data Units (PDUs) header of IEEE 1722.

33. The method of claim 31, wherein the 4-bit state field indicates at least one of the following states: D (Discovery), C (Claimed), V (Vacant), R (Registered), I (Inquiry), P (Proposal), O (Offered), A (Address), N (Null), T (Token), or corresponding states for the Register, RD, RC, RV and RX.

34. The method of claim 31, wherein the BARC identifier or address is based on or comprises a medium access control (MAC) address for a device receiving the BARC communications.
